(19) United States
(12) Patent Application Publication
(10) Pub. No.: US 2026/0326962 A1
(43) Pub. Date: Oct. 22, 2026

(54) LABELING MACHINE AND LABEL APPLICATION SYSTEM AND METHOD

(71) Applicant: Dover Europe Sàrl, Vernier (CH)

(72) Inventor: Jonas Södergård, Vastra Frolunda (SE)

(21) Appl. No.: 19/100,451

(22) PCT Filed: Aug. 1, 2023
(86) PCT No.: PCT/EP2023/071284

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B65C 9/36; B41J 3/407; B65C 9/00; B65C 9/18; B65C 9/42

(52) U.S. Cl. CPC B65C 9/36; B41J 3/4075; B65C 9/0006; B65C 9/1884; B65C 9/42

(57) ABSTRACT

The disclosure lates to a labelling system configured to apply a label on an object, including: a label feeder configured to feed a label stock with labels on a carrier to a label output where the label is released from the carrier; a labelling machine comprising: an application device with a label receiver surface configured to receive the label; a label attraction device communicating with the label receiver surface; and an actuator operatively connected to the application device and configured to displace the application device between a label receive position and a label apply position. The actuator is configured to: place the application device in the label receive position such that the label receiver surface is parallel with a label travelling direction from said label output; and displace the application device from the label receive position to the label apply position while the label feeder feeds the label stock.

### TECHNICAL FIELD

The disclosure relates generally to relocating a label from a source on an object. In particular aspects, the disclosure relates to labeling machines and a system, and a method for label application. The labelling machines and teachings of the disclosure can be applied in connection with industrial printers. Although the disclosure may be described with respect to a printer, the disclosure is not restricted to using a printer, and may be applied to any pre-printed label feeder and applicator arrangement.

### BACKGROUND

A labelling machine is used to apply labels to packaging or products. In addition to applying labels. Some known labelling machines comprise a label dispenser that supplies pre-printed labels from a source and an applicator that applies the pre-printed labels to an article. Other known labelling machines may print information onto labels immediately before printed labels are applied to an article. Such labelling machines may be referred to as print and apply labelling machines. In some other known labelling machines, an over-printing function may be used that over-prints parts of a label before application of the label.

A labelling printer or a standalone labelling machine may comprise a tape drive which advances the label stock from a supply spool support to a take up spool support. The tape drive may have a driver roller of known diameter which is accurately driven to achieve desired linear movement of the label stock along the backing paper path. The label stock may be pressed against the driver roller by a nip roller, in order to mitigate risk of slip between the driver roller and the label stock. Labels are removed from the moving backing paper by passing the label stock under tension around a labelling peel beak, or a peel blade or a label separating beak under a predetermined optimum tension in the backing paper of the label stock.

There is a growing demand for sustainable products and solutions, particularly in every stage of product manufacturing. Label printers and especially industrial label printers are utilized at various points in a production line and are included in sustainability requirements. Industrial label printers are specifically designed for heavy-duty, continuous use in larger-scale labelling operations commonly found in warehouses, factories, and distribution centres. These printers can produce thousands of labels per day. Additionally, industrial label printers may also include a label application component, collectively referred to as Print and Apply (P&A) machines.

Current P&A machines rely on compressed air for reliable operation. FIG. 1 illustrates an exemplary label printing machine 10 in communication with a label applicator portion 11. The applicator portion 11 comprises an applicator surface 12 that receives a label dispensed from the label printer 10 after that the label 13 has been printed. Typically, a compressed air stream (realized as an arrow) from a nozzle 14 is utilized to guide or force the label 13, which is printed by a printhead 15 of the label printer, onto the surface 12 of the applicator. Without compressed air, the label could be distanced from the surface and not applied onto the product.

This dependence on compressed air can present several disadvantages. Firstly, processes that utilize compressed air tend to be less energy efficient. This is primarily due to factors such as heat losses and air leakage. Moreover, maintaining a compressed air system incurs significant costs, which further contributes to the drawbacks.

In certain standalone label dispensers or P&A machines, a fan might be utilized to blow and guide the label onto the applicator, necessitating additional parts.

Currently, there are no completely reliable airless P&A or label supplier solutions available in the market. This is because of the conventional method of feeding labels from the printer to the applicator. Normally, a label is fed at an angle away from the applicator surface and then blown back towards the surface using an air flow (compressed air or fan generated), known as an air assist or support blow. The applicator is typically equipped with an attraction solution, such as negative air pressure generated by vacuum or a suction fan to keep the label in place on the applicator surface during the print and apply process.

In this “traditional” method, the applicator remains stationary at a designated “home” position, usually located slightly below the dispensing edge or peeler bar, while the label is printed and fed onto it. Once the printing process is completed, the label separates from the backing paper or liner and settles automatically in a position just below the dispensing edge or peeler bar, at a safe distance from other labels and the backing paper or liner. This separation is crucial and if not well designed, it allows for potential errors in the production process that might hinder the labels from easily detaching from the backing paper, being guided, and attached to the applicator surface in a label receiving position (home position). Achieving this reliable “home” position has been effectively accomplished by employing pneumatic or other driver components with fixed end positions to operate the applicators. This process has demonstrated its effectiveness in ensuring consistent and reliable operation.

As mentioned earlier the applicator can use vacuum created by compressed air or instead a fan to generate a suction effect to keep the label on the surface of the applicator. However, it is not easy to replace the compressed air used to push the label back against the applicator. There are solutions where a fan replaces the support blow/air assist, but fans are not well suited for creating a local high air pressure for directing the label onto the applicator surface.

### SUMMARY

The present disclosure presents arrangements and methods that eliminate the use of air flow to direct a label onto the surface of an applicator portion, and thereby reducing need for additional parts and costs for generating and directing compressed air, for example in an applicator or a printer.

According to a first aspect, the objective is achieved by a labelling system configured to apply a label on an object. The labelling system comprising: a label feeder comprises a label stock with labels on a carrier and the label output where the label is released from the carrier; a labelling machine comprising: an application device with a label receiver surface, which is configured to receive the label from a label output of the label feeder; a label attraction device communicating with the label receiver surface; and an actuator operatively connected to the application device and configured to displace the application device between a label receive position and a label apply position. The actuator is configured to: place the application device in the label receive position such that the label receiver surface is substantially parallel with a label travelling direction from said label output; and the actuator is configured to displace the application device from the label receive position to the label apply position while the label feeder actuates the carrier.

According to a second aspect, the objective is achieved by a labelling machine configured to apply a label on an object. The labelling machine comprising: an application device with a label receiver surface, which is configured to receive the label from a label output of a label source; a label attraction device communicating with the label receiver surface, and an actuator operatively connected to the application device and configured to displace the application device between a label receive position and a label apply position. The actuator is configured to: place the application device in the label receive position such that the label receiver surface is substantially parallel with a label travelling direction from said label output; and initiate a displacement of the application device from the label receive position towards the label apply position while the label being fed and not completely received on the label receiver surface.

According to a third aspect, a method of applying a label on an object by means of a labelling machine is provided, where labels are fed from a label output to the labelling machine. The method comprises: receiving the label on a label receiver surface of the labelling machine substantially parallel with a label travelling direction from the label output; and receiving the label on a label receiver surface of the labelling machine substantially parallel with a label travelling direction from the label output.

The present disclosure herein affords many advantages, of which a non-exhaustive list of examples follows:

According to some exemplary embodiments, the arrangement of the present disclosure prevents that a next label does not collide with the label on the applicator pad adding additional security in label applications. The arrangement of the disclosure saves time in print and apply applications, as a label is applied while the printer continues printing next label.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

With reference to the appended drawings, below follows a more detailed description of aspects of the disclosure cited as examples. Reference is made to the attached drawings, wherein elements having the same reference number designation may represent like elements throughout.

FIG. 1 is schematics of a print and apply system according to prior art;

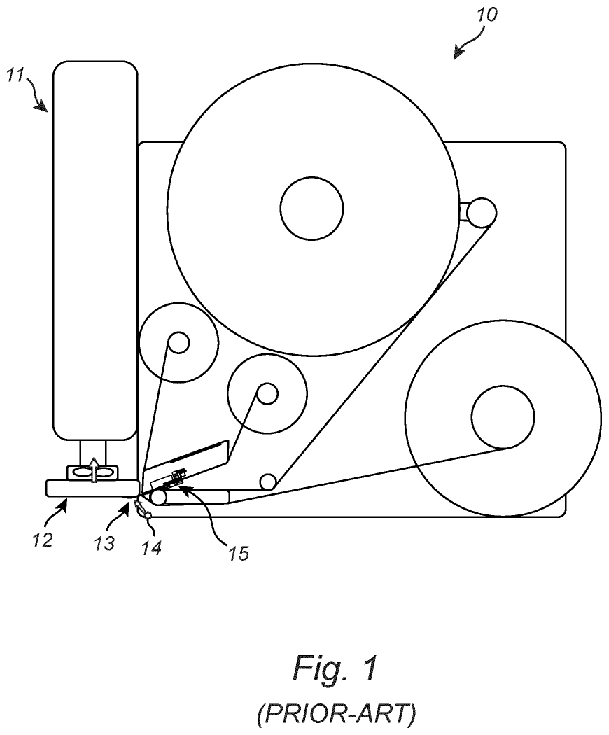

FIG. 2 illustrates a schematic view of a print and apply system in which methods and arrangements described herein are implemented;

FIG. 3 depicts the enlarged rectangular dashed portion in FIG. 2;

FIGS. 4-9 illustrate schematically feed of a label in accordance with teachings of present disclosure;

FIG. 10 illustrates schematically another embodiment of a feed of a label in accordance with teachings of present disclosure;

FIG. 11 illustrates a schematic view of sensor arrangements and a controller in one exemplary P&A system according to one aspect of the present disclosure;

FIG. 12 illustrates a schematic frontal view of a label printer according to one aspect of the present disclosure;

FIG. 13 illustrates exemplary steps of a method of the present disclosure; and

FIG. 14 is a block diagram illustrating the exemplary controller in FIG. 11.

### DETAILED DESCRIPTION

The term “industrial printer”, also known as an “industrial-grade printer”, as used herein, may refer to a type of printer specifically designed for heavy-duty printing tasks in industrial environments. These types of printers are built to manage large volumes of printing, often with high-speed and precision, and are capable of printing on various materials such as paper, cardboard, labels, plastics, and metals. The industrial printers, as referred to herein, may commonly be used in sectors like manufacturing, logistics, packaging, and retail, where there is a need for efficient and reliable printing solutions.

They are typically more robust and durable compared to standard office printers, as they are required to withstand harsher conditions and extended operation periods.

Depending on the specific application, industrial label printers may utilize different printing technologies. Some common types may include:
Thermal Transfer Printers (TTP): These printers use heat to transfer ink from a ribbon onto the printing material, such as labels or tags. They are widely used for barcode printing and labeling applications.
Direct Thermal Printers (DTP): These printers use heat-sensitive paper that turns black when exposed to heat, creating the desired print. They are commonly used for printing receipts, shipping labels, or temporary labels.
Inkjet Printers: Industrial inkjet printers use inkjet technology to propel tiny droplets of ink onto the printing surface. They can print high-resolution images and are suitable for printing on various materials, including paper, plastics, and metals.
Laser Printers: Industrial laser printers use laser technology to create the desired print. They are often used for high-speed and high-volume printing applications.

Industrial printers may also incorporate additional features, such as advanced connectivity options, rugged enclosures, automatic label applicators, online verification, imaging solutions, or integrated systems for data management and control. These features enhance their productivity, efficiency, and integration with other industrial processes.

The term “label”, as used herein, may include an information carrier media which can be made of several types of materials, depending on the specific requirements and application. Some common materials used for printer labels may for example include (but not limited to): paper, synthetic materials, cardstock, clear and transparent materials, thermal labels, and specialty materials.

The term “label backing paper” or “liner”, as used herein, may comprise a carrier and the carrier may be made of different materials and sizes. The carrier may comprise a protective layer that covers the adhesive side of a label before it is applied to a surface. It is designed to be easily peeled off, allowing the label to be stuck in place.

In the following disclosure, references are made to “print and apply” applications, i.e., applications in which a printer, especially a label printer and in particular an industrial label printer, prints on a label carried on a backing paper and dispenses it to an applicator, which applies the label on a product. However, the applicator may likewise be in communication with a dispenser, dispensing preprinted labels.

In the following disclosure, references are made to a thermal printer using a thermal ink ribbon for printing on a label. However, the teachings of the present disclosure are applicable in communication with any type of suitable printing technologies and/or label dispensers.

To eliminate the need for air flow for directing the label onto the surface of an applicator, it is suggested to:
Feed/print the label at a low or no angle, i.e., with respect to the receiver surface, so that there is no need to push the label against the applicator;
Control the position of the applicator such that it has one position during the first part of the feed/print process and subsequently moves to a second position or intermediate position at the end of the feed/print process. This second position could be about 0.1-10 mm, preferably 1-4 mm and most preferably 1-2 mm distanced from the first position and the switch to the second position could be done when there is just a 1-3 mm left to feed/print. The mentioned distance may be in any direction depending on the printer-applicator feed position.

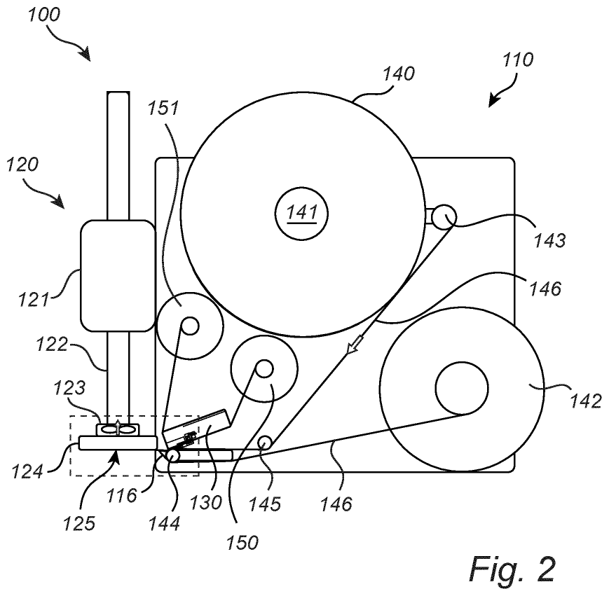

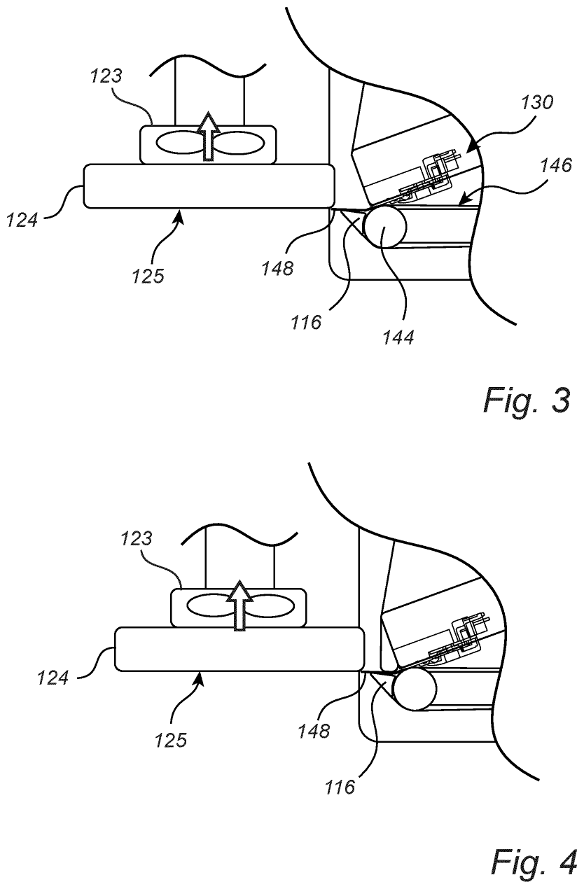

FIG. 2 illustrates an exemplary P&A system 100 and FIG. 3 is an enlargement of the area indicated with dashed lines in FIG. 2.

The exemplary schematic system 100 comprises an exemplary label printer 110 and an exemplary applicator 120.

The label printer 110 comprises a printhead 130, a label supply spool 140 of label stock mounted to a supply spool support 141, a take up spool 142, an ink ribbon supply spool 150, an ink ribbon take-up spool 151, and a number of rollers 143; 144 and 145.

The label stock extends along a web path 146 from the supply spool 140 around the first roller 143, one side of the second roller 145, around a labelling peel beak 116, and is wound onto the take up spool 142.

The ink ribbon extends from the supply spool 150, passes the printhead's 130 print elements (not shown) and is wound onto the take up spool 151. During the printing operation, the ink carried on the ribbon is transferred to the label substrate which is to be printed. To affect the transfer of ink, the printhead is brought into contact with the ribbon, and the ribbon is brought into contact with the label substrate and pressed onto the roller 144.

In some exemplary embodiments, the number of rollers may be more or less than three. In some exemplary embodiments, the ink ribbon drive system and label drive may comprise additional parts for extending the web.

The applicator 120 comprises an applicator actuator 121, an applicator arm 122, a label attraction device 123 and an applicator portion 124 comprising a label receiving surface 125.

In some exemplary embodiments the applicator actuator 121 may comprise an electrical motor with suitable gear configuration to displace the actuator arm 122. In another exemplary embodiment, the actuator may comprise a pneumatic device. In some exemplary embodiments, the actuator arm can be connected to the applicator portion on any position on the applicator portion. In some exemplary embodiments, the actuator may be mounted on top side or be integrated with the arm or applicator.

In some exemplary embodiments, the label attraction 123 device may comprise a vacuum generating pump or a fan that through holes (not illustrated) on the surface of the label receiving surface 125 generates a suction force and attracts the label onto the surface 125. In some exemplary embodiments, a statical charge may be used, i.e., the surface 125 may be charged with positive or negative charges and the label with opposite charge so that it is attracted onto the surface 125.

In some exemplary embodiments, the applicator portion 124 may be made of a metallic or plastic (or a suitable rigid or flexible material) comprising an internal chamber for generating and/or distributing vacuum.

The system 100 according to the present disclosure is configured to apply a label 148 on an object (not shown).

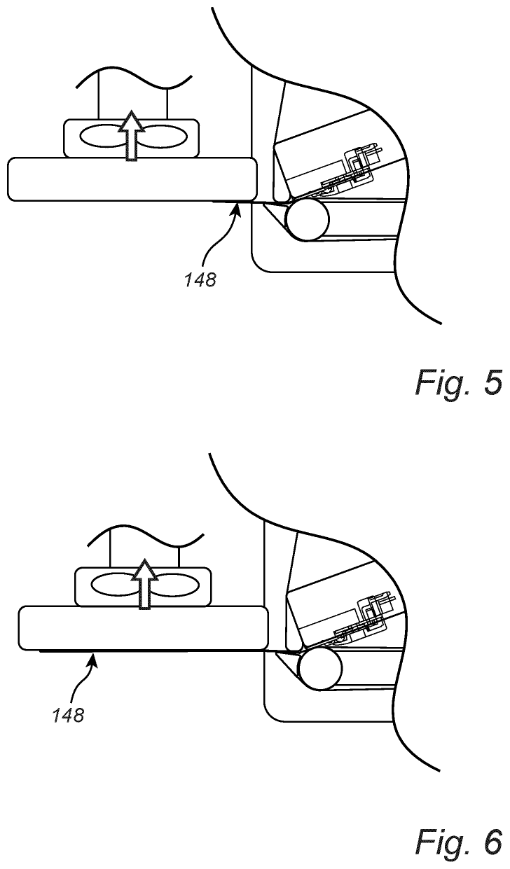

FIG. 4 illustrates the same elements as in FIG. 3 in which a label 148 is printed and in its travel path over the peel beak 116. The label has started to be detached from the moving web by passing the label backing paper under tension around the peel beak 116. The applicator portion and its label receiving surface 125 is slightly above the travelling path of the peeled label 148. Obviously, in the case of a label dispenser application, the printhead portion is not present and no printing is carried out.

In FIG. 5, the label 148 is further peeled and fed (with its non-sticky side) onto the label receiving surface 125. At this moment, the label attraction device 123 is operational and is attracting the label onto the surface 125. The attraction device 123 may start with a lower power to not disturb label feed onto the surface. In this embodiment, the label is fed at a low or no angle, i.e., with respect to the label receiver surface, so that there is no need to push the label against the applicator. The applicator is at its first position (label receiving or home position) during this first part of the feed/print process. The term “home position” refers to a position of the applicator portion 124 where the applicator surface is close to the feeding point from the printer or the label dispenser when receiving the label. The home position is thus a distance between the applicator surface and the label out-feed point, being at least the thickness of a label.

According to FIG. 6, a substantial part of the label is fed onto the label receiver surface.

In FIG. 7, the label is almost completely detached from the backing paper and displaced onto the surface. The applicator has started to move to a second position, i.e., passing a position aligned substantially with the label's feed level, realized by the dashed line. The detection process of label end attached to backing paper will be described in more detail below. The displacement of the applicator to the second position can start when there is just, e.g., 1-3 mm left of label to feed/print.

FIG. 8 Depicts the End of the Feed/print Process With Only the End Edge of the Label attached to the backing paper.

In FIG. 9, the entire label is detached from the backing paper and the applicator has reached its second position, which can be approximately 0.1-10 mm, preferably 1-4 mm and most preferably 1-2 mm distanced from the first position. The distance may be in any direction depending on the printer-applicator feed position.

The label applicator will, after receiving the entire label, i.e., when the label is entirely torn off the backing paper continue until the label with its adhesive side is applied on the surface of the object to be labelled. When the label is applied, the applicator is relocated to the previously mentioned first position to receive a new label.

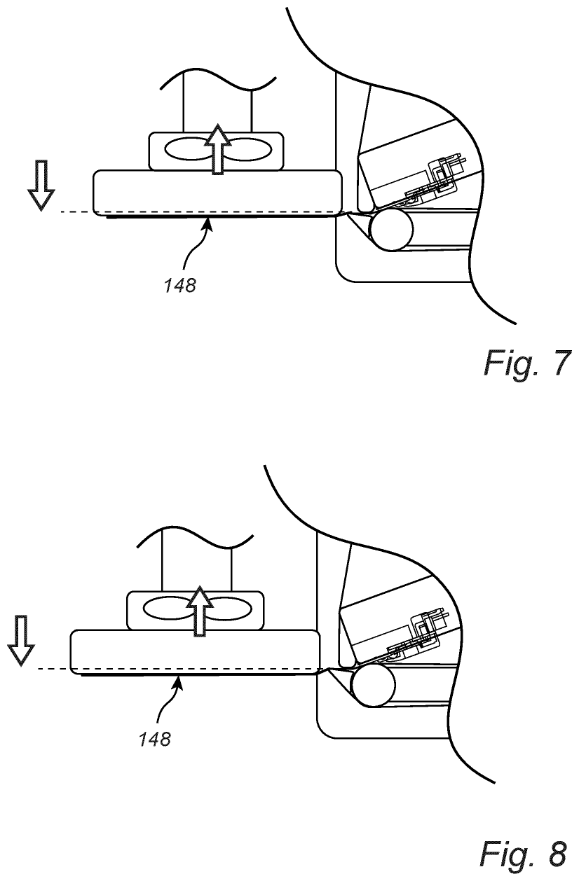

FIG. 10 illustrates yet another embodiment of the print and feeding portion of an exemplary label printer in which the label web path 146 is directed towards the printhead in a negative angle (compared to FIG. 3) but straitened after printhead 130 by means of a nose 135, comprising a contact and guide surface, and forward portion 1161 of the peel beak 116.

In one exemplary embodiment, the label may be directed upwards towards the label receiver surface. It may also be possible to feed the label in a very small negative angle, i.e., away from the surface of the label receiver. Consequently, the feeding angel with respect to the label receiver surface may be −3°≤feed angel≤10°.

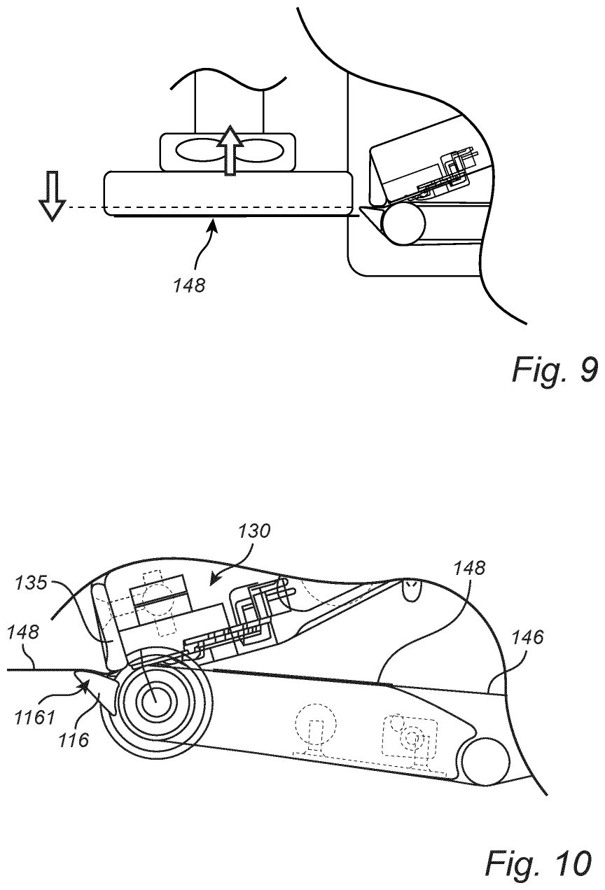

FIG. 11 illustrates schematically an exemplary controller 200 configured to control the operation of the applicator 120. The controller receives sensor signals, according to this example, from two sensors 170 and 175. The controller 200 may also receive signals from a printer controller 119. In one embodiment the controllers 119 and 200 may be combined.

The sensor 170 is a position sensor used to measure the position or displacement of the arm 122. The sensor 170 may comprise one of, but not limited to: a potentiometer, Linear Variable Differential Transformer (LVDT), optical encoder, hall effect sensor, capacitive/inductive proximity sensor, ultrasonic sensor, or magnetic encoder, etc.

The sensor 175 may comprise a gap sensor used to detect or measure the distance or gap between two labels. The sensor 175 may comprise a transmitter 176 and a receiver 175 in one example. The sensor 175 may comprise one of, but not limited to: an optical sensor, capacitive/inductive proximity sensor, ultrasonic sensor, laser sensor, eddy current sensor, Variable Differential Transformer (LVDT), or hall effect sensor, etc.

In operation, the sensor (pair) 175 detects the gap between the labels and provides a signal to the controller 200. The controller may obtain information about the print speed and label feed speed from the printer controller 119. By having information about when the front edge of the label 148 passes the sensor 175, the size of the gap between the labels (if necessary), label size (length or width, depending on the label feed direction) and label feed speed, the controller calculates when to initiate the applicator actuator to start displacing the applicator from home position.

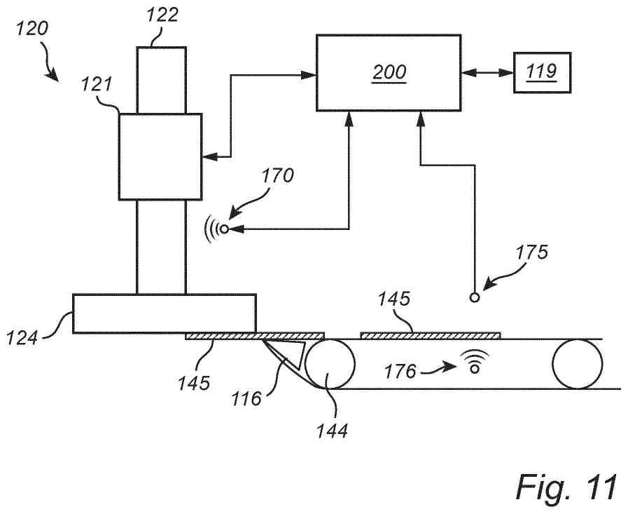

The controller 200 operates the applicator actuator 121 and receives position information for applicator arm 122 from the position sensor 170. The position signal may be an absolute signal, i.e., when the applicator arm 122 is in certain positions or displacement, e.g., information about how the arm is displaced. After a label application the process of receiving a new label on the applicator and applying the label may comprise the exemplary steps as illustrated in the flow diagram of FIG. 12:
(1) The controller may receive a signal (or calculate) when the applicator portion 124 is in the home position to receive a label;
(2) If not, the applicator is displaced until the controller receives a signal from the sensor 170 confirming applicators home position, the applicator portion 124 is displaced to reach the home position;
(3) When the applicator is in the home position, the controller 200 instructs the printer to print and/or feed the label;
(4) The controller calculates and monitors that the label is fed y=L−x (L=label length and x=predetermined length left on the backing paper) onto the applicator surface;
(5) When the label is in y-position, the controller instructs the actuator 121 to displace the applicator;
(6) the Controller Monitors the Displacement of the Applicator Until it Reaches its

second position;
(7) When the applicator reaches position 2, the label is completely detached from the backing paper and the applicator is instructed to apply the label on a product;
(8) The controller monitors the position of the arm 122 to detect I the label is applied. Here other sensor may provide additional information about the label application.
(9) When the label application is confirmed, the applicator is moved to the home position.

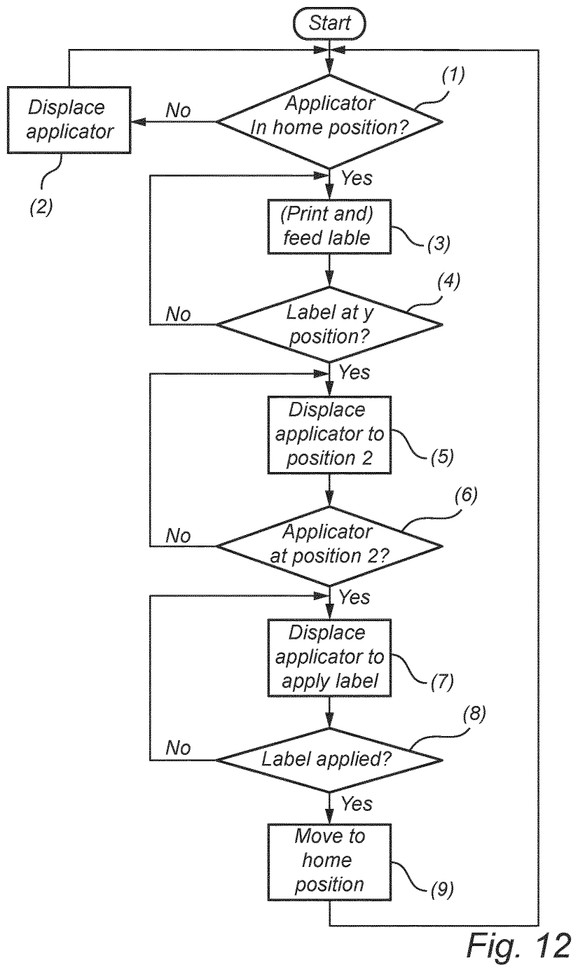

FIG. 13 illustrates an exemplary configuration of the gap sensor 175 for label gap detection, according to one embodiment. According to this configuration, the media sensor 175 comprising two parts, a transmitter part for sending a signal and a receiver part 175 for receiving the signal are arranged such that a part is located in a portion under a path for passing the label web and the other part of the sensor is located in such way that the at least two parts form vertexes of a triangle and the signal path a triangle side, such that the vertex angels are different from 90 degrees. The transmitter part can be arranged on a bottom supporting part 117 and the receiver on a support wall plate 118.

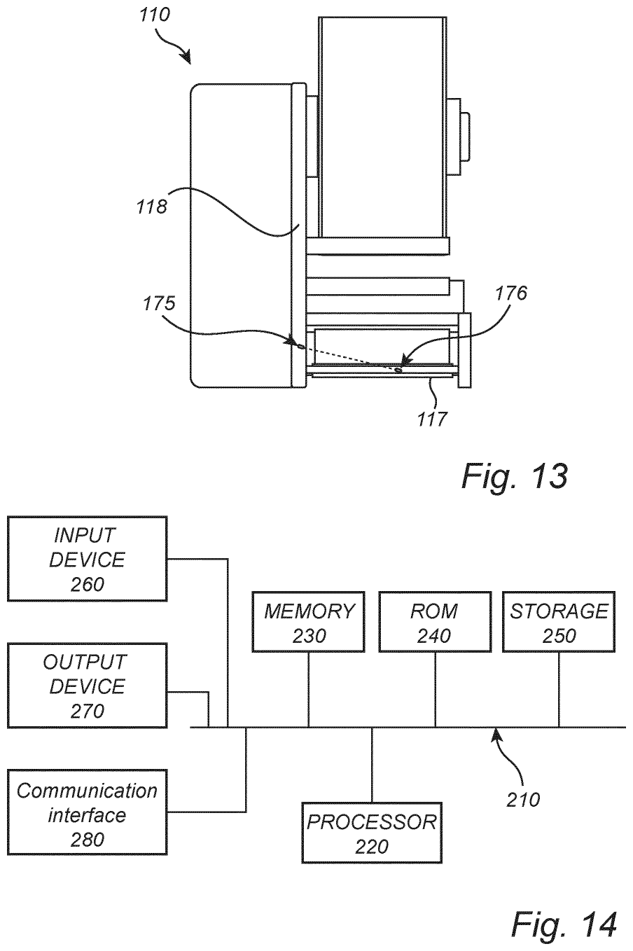

FIG. 14 is a diagram of an exemplary controller 200 as described earlier. The controller 200 may include a bus 210, a processor 220, a memory 230, a read only memory (ROM) 240, a storage device 250, an input device 260, an output device 270, and a communication interface 280. The bus 210 permits communication among the components of controller 200. The bus may be any of several types of bus structures that may further interconnect to a memory bus (with or without a memory controller), a peripheral bus, and/or a local bus using any of a variety of bus architectures. The controller 200 may also include one or more power supplies (not shown). One skilled in the art would recognize that controller 200 may be configured in a number of other ways and may include other or different elements.

The processor 220 may include any type of processor or microprocessor that interprets and executes instructions. The processor 220 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor may further include computer executable code that controls operation of the programmable device. The processor 220 may also include logic that is able to receive and compile instructions and interpret different signal, and also generate output to, for example, a speaker, a display, etc.

The memory 230 may include a random-access memory (RAM) or another dynamic storage device that stores information and instructions for execution by processor 220. Memory 230 may also be used to store temporary variables or other intermediate information during execution of instructions by processor 220. The memory 230 may be one or more devices for storing data and/or computer code for completing or facilitating methods described herein. The memory may include database components, object code components, script components, or other types of information structure for supporting the various activities herein. Any distributed or local memory device may be utilized with the systems and methods of this description. The memory may be communicably connected to the processor device (e.g., via a circuit or any other wired, wireless, or network connection) and may include computer code for executing one or more processes described herein. The memory may include non-volatile memory 240 (e.g., read-only memory (ROM), erasable programmable read-only memory (EPROM), electrically erasable programmable read-only memory (EEPROM), etc.), and volatile memory (e.g., random-access memory (RAM)), or any other medium which can be used to carry or store desired program code in the form of machine-executable instructions or data structures and which can be accessed by a computer or other machine with a processor. A basic input/output system (BIOS) may be stored in the non-volatile memory 240 and can include the basic routines that help to transfer information between elements within the controller.

ROM 240 may include a conventional ROM device and/or another static storage device that stores static information and instructions for processor 220. Storage device 250 may include a magnetic disk or optical disk and its corresponding drive and/or some other type of magnetic or optical recording medium and its corresponding drive for storing information and instructions. Storage device 250 may also include a flash memory (e.g., an electrically erasable programmable read only memory (EEPROM)) device for storing information and instructions.

Input device 260 may include one or more conventional mechanisms that permit a user to input information to the controller 200, such as a keyboard, a keypad, a directional pad, a mouse, a pen, voice recognition, a touch-screen and/or biometric mechanisms, etc. Output device 270 may include one or more conventional mechanisms that output information to the user, including a display, a printer, one or more speakers, etc. Communication interface 280 may include any transceiver-like mechanism that enables controller 200 to communicate with other devices and/or systems. For example, communication interface 280 may include a modem or an Ethernet interface to a LAN. Alternatively, or additionally, communication interface 280 may include other mechanisms, such as serial or parallel ports or for communicating via a network, such as a wireless network. For example, communication interface may include a radio frequency (RF) transmitter and receiver and one or more antennas for transmitting and receiving RF data.

The controller 200, consistent with the disclosure, provides a platform through which the various functions of applicator stand alone or in combination with a printer are controlled. The controller 200 may also display information associated with the label application status of printer relevant information.

According to an exemplary implementation, controller 200 may perform various processes in response to processor 220 executing sequences of instructions contained in memory 230. Such instructions may be read into memory 230 from another computer-readable medium, such as storage device 250, or from a separate device via communication interface 280. It should be understood that a computer-readable medium may include one or more memory devices or carrier waves. Execution of the sequences of instructions contained in memory 230 causes processor 220 to perform the acts that have been described. In alternative embodiments, hard-wired circuitry may be used in place of or in combination with software instructions to implement aspects consistent with the invention. Thus, the invention is not limited to any specific combination of hardware circuitry and software.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A labelling system configured to apply a label on an object, the labelling system comprising:
a label feeder configured to feed a label stock with labels on a carrier from a source to a label output of the label feeder where the label is released from the carrier;
a labelling machine comprising:
an application device with a label receiver surface, which is configured to receive the label from the label output of the label feeder;
a label attraction device communicating with the label receiver surface so as to attract the label on to the label receiver surface; and
an actuator operatively connected to the application device and configured to displace the application device between a label receive position and a label apply position;
wherein the actuator is configured to:
place the application device in the label receive position such that the label receiver surface parallel with a label travelling direction from said label output; and
displace the application device from the label receive position to the label apply position while the label feeder feeds the label stock.

2. The labelling system according to claim 1, wherein the actuator is further configured to commence displacement of the application device from the label receive position to the label apply position when an end portion of the label is in contact with the carrier of the label stock.

3. The labelling system according to claim 1, wherein the actuator is configured to displace the application device from the label receive position to the label apply position, wherein the label receive position and the label apply position are located on opposite sides of the label output.

4. The labelling system according to claim 1, wherein the label attraction device includes one or more of a fan, a vacuum generating arrangement or a static charging device.

5. The labelling system according to claim 1, further comprising a controller configured to control displacement of the applicator device.

6. The labelling system according to claim 5, wherein the controller is configured to communicate with a controller of the label feeder and to receive control signals from the label feeder.

7. The labelling system according to claim 1, wherein a feeding angle, α, from the label output with respect to the label receiver surface is −3°<α<+10°, wherein a positive angle is subtended towards the label receive position.

8. The labelling system according to claim 1, wherein the label feeder is a label dispenser.

9. The labelling system according to claim 1, wherein the label feeder includes a label printer.

10. The labelling system according to claim 9, wherein the label printer is an industrial label printer.

11. The labelling system according to claim 1, wherein the label feeder comprises a label detaching portion having a surface configured to detach the label from the carrier and the label detaching portion is arranged parallel to the label receiving surface.

12. A labelling machine configured to apply a label on an object, the labelling machine comprising:
an application device with a label receiver surface, which is configured to receive the label from a label output of a label source;
a label attraction device communicating with the label receiver surface so as to attract the label on to the label receiver surface; and
an actuator operatively connected to the application device and configured to displace the application device between a label receive position and a label apply position;
wherein the actuator is configured to:
place the application device in the label receive position such that the label receiver surface is parallel with a label travelling direction from said label output; and
initiate a displacement of the application device from the label receive position towards the label apply position while the label is being fed from the label output to the label receiver surface and not completely received on the label receiver surface.

13. The labelling machine according to claim 12, wherein the actuator is configured to displace the application device from the label receive position to the label apply position, wherein the label receive position and the label apply position are located on opposite sides of the label output.

14. The labelling machine according to claim 12, or further comprising a controller configured to control displacement of the applicator device.

15. The labelling machine according to claim 12, wherein the label attraction device includes one or more of a fan, a vacuum generating arrangement or a static charging device.

16. A method of applying a label on an object by means of a labelling machine, wherein labels are fed from a source to a label output by a label feeder and to the labelling machine, the method comprising:
positioning a label receiver surface of the labelling machine in a label receive position parallel with a label travelling direction from the label output,
receiving the label on the label receiver surface of the labelling machine parallel with the label travelling direction from the label output; and
beginning to displace the label receiver surface to a label apply position before the label has been completely fed from the label output to the label receiver surface.

17. The method of claim 16, further comprising:
determining if the label receiver surface is in the label receive position to receive the label;
if the label receiver surface is not in the label receive position, displacing the label receiver surface until the label receiver surface is in the label receive position to receive the label from the label feeder;
feeding by the label feeder the label a distance y onto the label receiver surface, wherein y=L−x, L=label length and x=a predetermined length left on a label carrier;
displacing the label receiver surface when the label is in y-position and continuing to displace the label receiver surface until the label is detached from the carrier;
displacing the label receiver surface until the label is receiver surface is in the label apply position;
detaching the label from the label receiver surface; and
returning the label receiver surface to the label receive position.
